(19) United States
(12) Patent Application Publication
(10) Pub. No.: US 2006/0244418 A1
(43) Pub. Date: Nov. 2, 2006

(54) Battery module of portable electronic device

(75) Inventors: Chi-Cheng Liao, Taipei (TW); Iou-Ren Su, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer, Inc.

(21) Appl. No.: 11/401,038

(22) Filed: Apr. 10, 2006

(30) Foreign Application Priority Data
Apr. 28, 2005 (TW) 94113722

(51) Int. Cl. H02J 7/00

(52) U.S. Cl. 320/112

(57) ABSTRACT

A battery module of a portable electronic device comprises a shell structure, a first battery, a second battery, and an engaging set. The shell structure having a plurality of electrodes forms an electrical connection with the first battery or with the second battery alternatively. The engaging set comprises a first engaging union and a second engaging union. When the first battery is selected, the first engaging union and the first battery are engaged together to form an electrical contact between the first battery and the electrodes. Alternatively, when the second battery is selected, the first engaging union and the second engaging union are engaged together to form an electrical contact between the second battery and the electrodes.

### RELATED APPLICATIONS

The present application is based on, and claims priority from, Taiwan Application Serial Number 94113722, filed Apr. 28, 2005, the disclosure of which is hereby incorporated by reference herein in its entirety.

### FIELD OF THE INVENTION

The present invention relates to a portable electronic device, and more particularly to a battery module of a portable electronic device.

### BACKGROUND OF THE INVENTION

Currently, the main trend for designing an electronic device emphasizes properties such as small size, portability and convenience. The trend especially influences the design of electronic-intelligent products, such as notebook computers, portable TVs, cell phones and PDAs.

A portable power supply is critical for providing portability to portable electronic products, and the battery is the most popular power supply for this purpose.

Since battery power capacity is rather limited, electronic products usually contain a replaceable battery module to prolong their operating times. For example, a backup battery may be provided to replace the expended battery of a cell phone to extend its operating time.

In order to decrease manufacturing costs, makers of electronic products may apply a common battery module to various products. Recently, the most popular common battery module is designed as a module allowing for two batteries with the same specification, a battery cover, and a cover engaging structure built on the products. When the working battery is exhausted, it may be replaced with the backup battery by taking off and reassembling the battery cover.

For applying the common battery to every product, the battery module is designed to allow for two batteries with different specifications and has two battery covers with different features tailored to the different battery types. However, the module is very inconvenient to carry since it requires a user to carry two battery covers for holding the two different batteries.

Another solution is to combine a battery with a cover to form a covered battery. This is more convenient for a user since it requires carrying less components. However, covered battery modules are very expensive for manufacturers since they do not share common parts among different products, necessitating the development of additional molds.

It is desired, therefore, to provide a battery module for an electronic device that can both share common parts among different products as well as provide a convenient way to replace the battery.

### SUMMARY OF THE INVENTION

The objective of present invention is to provide a battery module for an electronic device that can both offer a convenient way to replace the battery as well as share common parts among different products so as to decrease the manufacturing cost.

In accordance with the preferred embodiments, a battery module of a portable electronic device is provided, wherein a first battery or a second battery is selectively engaged with the battery module. The battery module comprises a shell, a first battery, a second battery, and an engaging set.

The shell includes a first recess, a second recess, and a plurality of electrodes, wherein the normal vector of the first recess runs parallel to the normal vector of the second recess. There is a first opening located on the sidewall of the first recess, and the normal vector of the second recess is perpendicular to the normal vector of the first opening. The electrodes located in the first recess are electrically connected to the mainframe of the electronic device. The first battery or the second battery having an outer shell and a flange may be selected to contact the electrodes.

The engaging set comprises a first engaging union, a second engaging union, and a battery cover, wherein the first engaging union is built in the shell having a latch configured in the second recess. One end of the latch protrudes out of the opening of the second recess, and the other end of the latch is restrained in the second recess.

There is a through-hole located on the sidewall of the battery cover, wherein the normal vector of the through-hole runs parallel to the latch. When the first battery is selected to contact the plurality of the electrodes, the battery cover blankets the first recess, and the through-hole is engaged with the latch; thus the battery cover and the sidewall of the first recess defines an encapsulated space for restraining the first battery to electrically contact the electrodes.

The second engaging union has a first U-shaped opening, a second U-shaped opening, and an engaging portion, wherein the normal vector of the first U-shaped opening is perpendicular to the normal vector of the second U-shaped opening. The engaging portion protrudes from the sidewall of the second engaging union within the second U-shaped opening. When the second battery is selected to contact the plurality of electrodes, the second battery engages the shell to form an electrical contact with the electrodes, wherein the flange of the second battery is sheathed by the first U-shaped opening, the portion of the latch protruding from the second recess is sheathed by the second U-shaped opening, and the engaging portion is engaged in the first opening.

Accordingly, the aforementioned embodiments providing an electronic device a battery module that selectively engages two different types of batteries has advantages that meet the objectives of the present invention: the user can replace and carry the backup battery conveniently, and different products made by the same manufacturer can share common parts among each other to decrease the manufacturing cost.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a side view of a shell on a cell phone in accordance with a preferred embodiment of present invention.

FIG. 2 illustrates a cross-sectional view of a shell on a cell phone in accordance with a preferred embodiment of present invention.

FIG. 3 illustrates a cross-sectional view of the first engaging union taken along the dotted line “S” of FIG. 1 in accordance with a preferred embodiment of present invention.

FIG. 4 illustrates a side view of the battery cover in accordance with a preferred embodiment of present invention.

FIG. 5a is a cross-sectional view illustrating the first engaging union assembled with the shell and the first battery during the assembly process, in accordance with a preferred embodiment of present invention.

FIG. 5b illustrates a cross-sectional view of the result after the first engaging union is assembled with the shell and the first battery, in accordance with a preferred embodiment of present invention.

FIG. 6 illustrates a cross-sectional view of the second engaging union of the engaging set in accordance with a preferred embodiment of present invention.

FIG. 7a is a cross-sectional view illustrating the second engaging union assembled with the shell and the second battery during the assembly process, in accordance with a preferred embodiment of present invention.

FIG. 7b illustrates a cross-sectional view of the result after the second engaging union is assembled with the shell and the second battery, in accordance with a preferred embodiment of present invention.

### DETAILED DESCRIPTION OF THE PREFERRED EMBODIMENT

The objective of the present invention is to provide a battery module of an electronic device. The feature of present invention is to apply a battery module that is selectable to engage two different types of batteries, such as batteries with different capacities or different features, so as to provide a convenient way of replacing the battery as well as to provide a means to share common parts among different products.

The aspects, objective, features and many of the attendant advantages of this invention will become more readily appreciated by reference to the following detailed description.

In accordance with the embodiments of the present invention, the battery module comprises a shell 100, a first battery 200, a second battery 300, and an engaging set 400. The following description of a preferred embodiment is presented with reference to a cell phone.

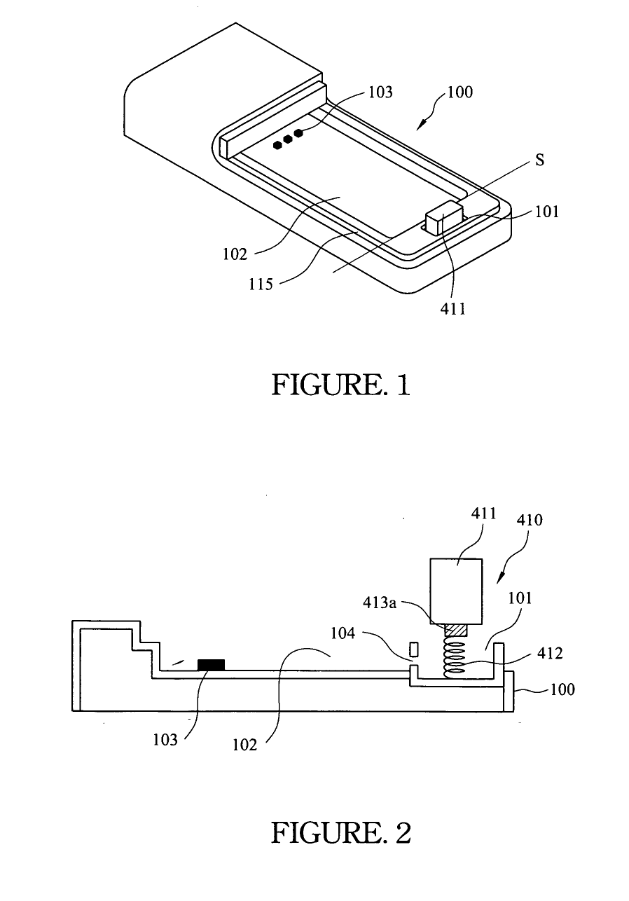

Referring to FIGS. 1 and 2, FIG. 1 illustrates a side view of a cell phone shell in accordance with a preferred embodiment of the present invention, and FIG. 2 illustrates a cross-sectional view of a cell phone shell in accordance with a preferred embodiment of the present invention. In the present embodiment, the shell 100 is one portion of the cell phone case, such as the rear panel of the cell phone. The shell 100 includes a first recess 102, second recess 101, and a plurality of electrodes 103, wherein the normal vector of the first recess 102 runs parallel to the normal vector of the second recess 101. There is a first opening 104 located on the sidewall of the first recess 102, and the normal vector of the second recess 101 is perpendicular to the normal vector of the first opening 104. The electrodes 103 located in the first recess are electrically connected to the mainframe of the electronic device.

In some embodiments of the present invention, the first battery 200 is a common battery of various products produced by the same manufacturer. The second battery 300 is the backup battery with a capacity different from the first battery 200, wherein the second battery 300 has an outer shell 301 and a flange 302 with a size and features customizable to match the design of various products.

The engaging set 400 comprises a first engaging union 410, a second engaging union 430, and a battery cover 420.

Referring to FIG. 2, the first engaging union 410 is built in the shell 100 having a latch 411 configured in the second recess 101. One end of the latch 411 protrudes out of the second recess 101, and the other end of the latch 411 is restrained in the second recess 101.

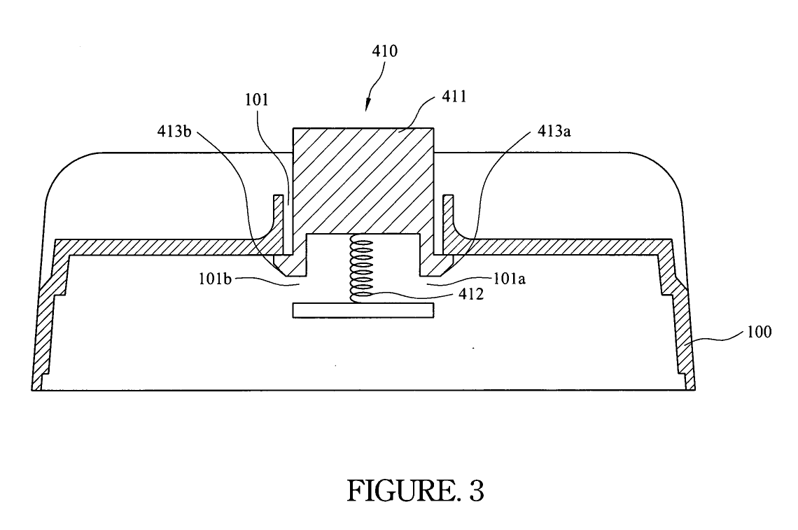

FIG. 3 illustrates a cross-sectional view of the first engaging union taken along the dotted line “S” in accordance with a preferred embodiment of the present invention. The first engaging union 410 further comprises a first spring element 412 and at least one claw portion, such as 413a and 413b. One end of the first spring element 412, such as a spring, is connected with the latch 411, and the other end of the first spring element 412 contacts the bottom of the second recess 101. The normal vector of the second recess 101 runs parallel to the elastic force of the first spring element 412, wherein the elastic force is used for pushing the latch 411 out of the second recess 101. The claw portions 413a and 413b are two bolts that protrude from the latch 411 and are fixed into the niches located on the sidewall of the second recess 101 to prevent the latch 411 from being completely pushed out of the second recess 101 by the elastic force of the first spring element 412.

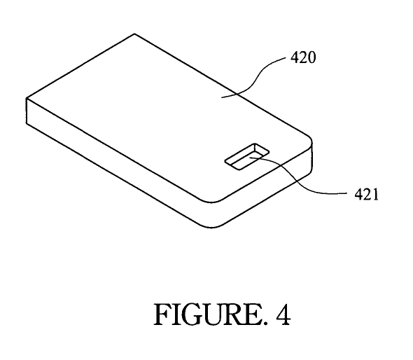

FIG. 4 illustrates a side view of the battery cover in accordance with a preferred embodiment of the present invention. There is a through-hole 421 located on the sidewall of the battery cover 420. In the present embodiment, the battery cover 420 is used for encapsulating the battery of the cell phone.

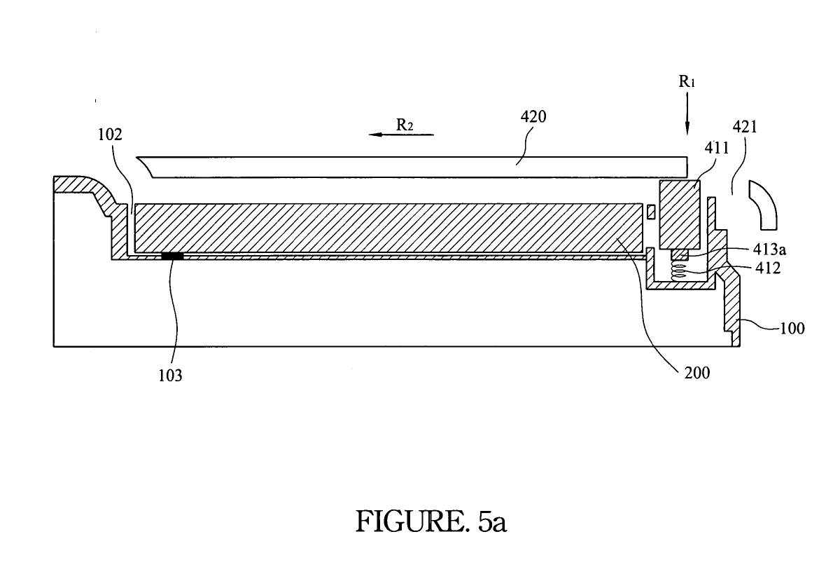

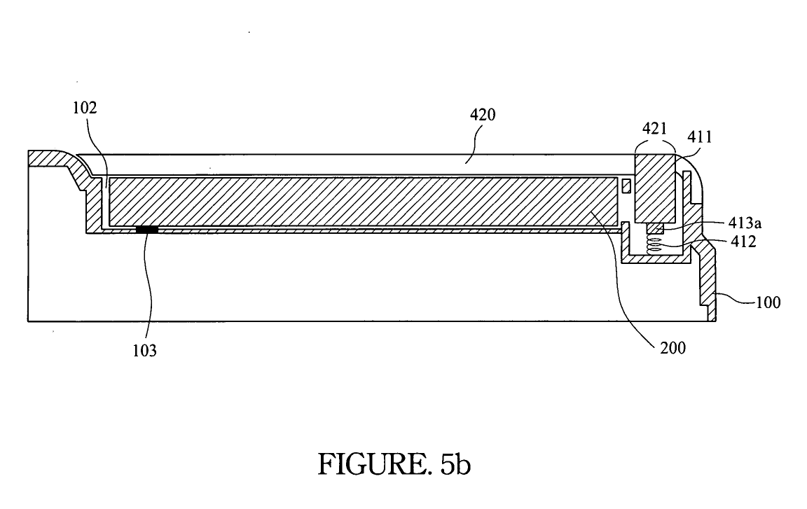

FIG. 5a is a cross-sectional view illustrating the first engaging union assembled with the shell and the first battery during the assembly process, in accordance with a preferred embodiment of the present invention. When the first battery 200 is selected to contact the plurality of electrodes 103, the latch 411 is pushed vertically into the second recess 101 (as indicated by the arrow “R1”). Then, the battery cover 420 covering the first recess 102 may be moved along the direction (as indicated by the arrow “R2”) that runs parallel to the shell 100 to force the through-hole 421 of the battery cover 420 to align with the latch 411. Subsequently, upon releasing the latch 411, the through-hole 421 of the battery cover 420 engages the latch 411 to allow the compressed first spring element 412 to thrust upward.

FIG. 5b illustrates a cross-sectional view of the result after the first engaging union is assembled with the shell and the first battery, in accordance with a preferred embodiment of the present invention. After the latch 411 engages the battery cover 420, the battery cover 420 and the sidewall of the first recess 102 defines an encapsulated space for restraining the first battery 200 to form an electrical contact with the electrodes 103.

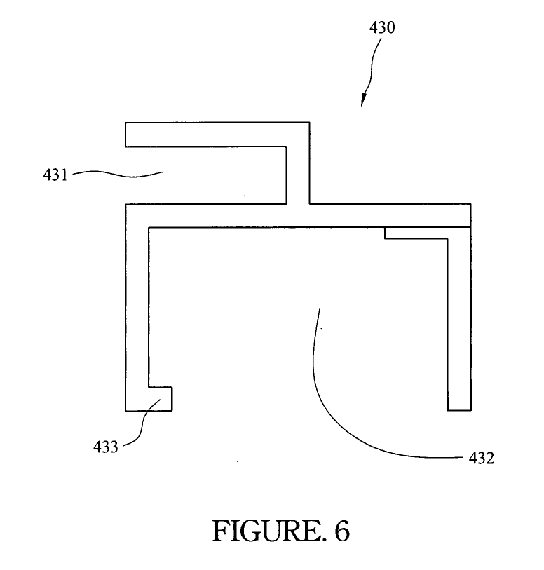

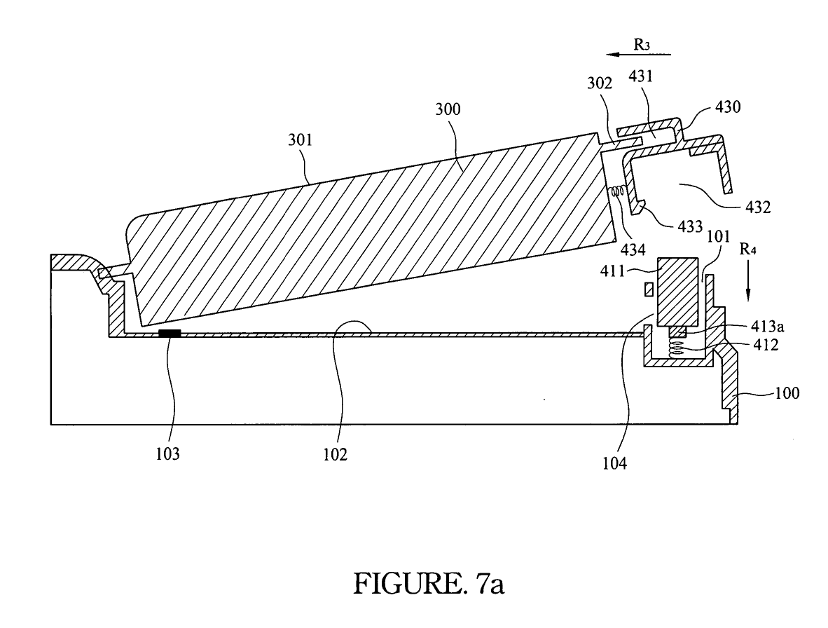

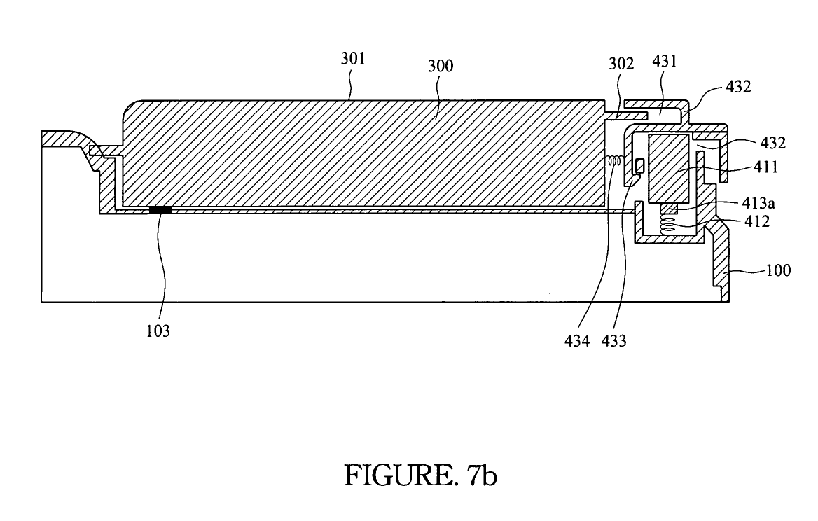

FIG. 6 illustrates a cross-sectional view of the second engaging union of the engaging set, in accordance with a preferred embodiment of the present invention. The second engaging union 430 has a first U-shaped opening 431, a second U-shaped opening 432, and an engaging portion 433, wherein the normal vector of the first U-shaped opening 431 is perpendicular to the normal vector of the second U-shaped opening 432, and the normal vector of the first U-shaped opening runs parallel to the normal vector of the first opening 104 located on the shell 100. The engaging portion 433 protrudes from the sidewall of the second engaging union 430 within the second U-shaped opening 432. The second engaging union 430 further comprises a second spring element 432 contacting the sidewall of the second engaging union 430 out of the second U-shaped opening 432 (as illustrated in FIG. 7a). For example, the second spring element 432 is a spring, wherein the direction of its elastic force runs parallel to the normal vector of the first U-shaped opening 431.

FIG. 7a is a cross-sectional view illustrating the second engaging union assembled with the shell and the second battery during the assembly process, in accordance with a preferred embodiment of present invention.

When the second battery 300 is selected to contact the plurality of electrodes 103, the flange 302 of the second battery 300 is sheathed within the second U-shaped opening 431 of the second engaging union 430, and the outer shell 301 contacts the second spring element 434 before the second spring element 434 is compressed. In the present embodiment, the second battery 300 is engaged with the second U-shaped opening 431 in advance for carrying convenience.

Subsequently, the second spring element 434 is compressed to force the second union 430 toward the second battery 300, wherein the movement of the second union 430 is indicated by the arrow “R3”, such that the second battery 300 engaged with the second union 430 fits into the first recess 102, and the portion of the latch 411 protruding out of the second recess 101 is sheathed by the second U-shaped opening (as indicated by the arrow “R4”). Upon releasing the second spring element 434 when the engaging portion 433 is aligned with the first opening 104, the engaging portion 433 is thrust by the compressed second spring element 434 into the first opening 104.

FIG. 7b illustrates a cross-sectional view of the result after the second engaging union is assembled with the shell and the second battery, in accordance with a preferred embodiment of present invention. After the engaging portion 433 engages the first opening 104, the second battery 300 engaged with the shell 100 forms an electrical contact with the electrodes 103.

In addition, the shell 100 further comprises a plurality of ribs or fillisters 115 to enable the assembly of the engaging unions onto the shell 100 (as illustrated in FIG. 1).

According to the aforementioned embodiments, an electronic device can be engaged with a battery of standard capacity (such as the first battery 200) as well as a battery with special attributes (such as the second battery 300) selectively via the battery module 400. The manufacturer of electronic device can choose the first battery 200 as the common battery that can share common parts with other products and choose the second battery 300 as a backup battery for convenient carrying.

Therefore, the present embodiment provides a developed battery module having advantages that meet the objectives of the present invention, wherein the user can replace and carry the backup battery conveniently, and different products made by the same manufacturer can share common parts among each other to decrease the manufacturing cost.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A battery module of a portable electronic device selectively engaged with a first battery or a second battery having a flange and an outer shell comprising:
a shell having a first recess, a second recess, and a plurality of electrodes, wherein the electrodes located in the first recess are electrically connected to the mainframe of the electronic device, and the electrodes are used for forming electrical contact with the first battery or the second battery selectively engaged in the first recess; and
an engaging set comprising:
a first engaging union built in the second recess to engage the first battery, wherein a portion of the first engaging union protrudes out of the second recess, and the other portion of the first engaging union is movably restrained in the second recess; and
a second engaging union used to engage the second battery and the first engaging union, wherein the outer shell of the second battery conforms to the shell and the second engaging union engaged therein.

2. The battery module of a portable device of claim 1, wherein the normal vector of the first recess runs parallel to the normal vector of the second recess, and the normal vector of a first opening located on the sidewall of the first recess is perpendicular to the second recess.

3. The battery module of a portable device of claim 1, the first engaging union further comprising a latch configured in the second recess, wherein one end of the latch protrudes out the second recess, and the other end of the latch is restrained in the second recess.

4. The battery module of a portable device of claim 3, wherein the first engaging union further comprises a first spring element, wherein one end of the first spring element is connected to the latch, the other end of the first spring element contacts the bottom of the second recess, and the elastic force of the first spring element runs parallel to the normal vector of the second recess.

5. The battery module of a portable device of claim 3, wherein the latch further comprises a claw portion protruding from the latch is fixed into the sidewall of the second recess to prevent the latch from being completely pushed out of the second recess by the elastic force of the first spring element.

6. The battery module of a portable device of claim 5, wherein the first spring element is a spring.

7. The battery module of a portable device of claim 1, wherein the second engaging union has a first U-shaped opening, a second U-shaped opening, and an engaging portion, wherein the normal vector of the first U-shaped opening is perpendicular to the normal vector of the second U-shaped opening, the normal vector of the first U-shaped opening runs parallel to the normal vector of the first opening located on the shell, and the engaging portion protrudes from the sidewall of the second engaging union within the second U-shaped opening.

8. The battery module of a portable device of claim 7, wherein the second engaging union further comprises a second spring element contacting the sidewall of the second engaging union out of the second U-shaped opening, wherein the direction of the elastic force of the second spring element runs parallel to the normal vector of the first U-shaped opening.

9. The battery module of a portable device of claim 1, further comprising a battery cover that conforms to the shell and the first battery engaged therein.

10. The battery module of a portable device of claim 10, wherein the battery cover comprises a through-hole located thereon.

11. The battery module of a portable device of claim 11, wherein when the first battery is selected to contact the electrodes, the latch engages the through-hole, and the battery cover and the sidewall of the first recess defines an encapsulated space for restraining the first battery to form an electrical contact with the electrodes.

12. The battery module of a portable device of claim 7, wherein when the second battery is selected to contact the plurality of electrodes, the flange of the second battery is sheathed moveably within the second U-shaped opening, the portion of the latch protruding out of the second recess is sheathed by the second U-shaped opening, and the engaging portion engages the first opening such that the second battery is engaged with the shell to form an electrical contact with the electrodes.

13. The battery module of a portable device of claim 1, wherein the shell further comprises a plurality of ribs or fillisters to enable the assembly of the engaging unions onto the shell.

14. A portable electronic device comprising:
a mainframe; and
a battery module connected to the mainframe, wherein the battery module selectively engages a first battery or a second battery having an outer shell and a flange;
and the battery module comprises:
a shell having a first recess, a second recess, and a plurality of electrodes, wherein the electrodes located in the first recess are electrically connected to the mainframe of the electronic device, and the electrodes are used to form electrical contact to the first battery or the second battery engaged in the first recess; and
an engaging set comprising:
a first engaging union having a latch built in the second recess, wherein one end of the latch protrudes out of the second recess, and the other end of the latch is restrained in the second recess;
a battery cover comprising a through-hole; wherein when the first battery is selected to contact the electrodes, the latch engages the through-hole so that the battery and the sidewall of the first recess defines an encapsulated space for restraining the first battery to form an electrical contact with the electrodes;
a second engaging union comprising a first U-shaped opening, a second U-shaped opening and an engaging portion, wherein the normal vector of the first U-shaped opening is perpendicular to the normal vector of the second U-shaped opening, the normal vector of the first U-shaped opening runs parallel to the normal vector of the first opening located on the shell, and the engaging portion protrudes from the sidewall of the second engaging union within the second U-shaped opening,
wherein when the second battery is selected to contact the plurality of electrodes, the flange of the second battery is sheathed moveably within the second U-shaped opening, the portion of the latch protruding out of the second recess is sheathed by the second U-shaped opening, and the engaging portion engages the first opening such that the second battery is engaged with the shell to form an electrical contact with the electrodes.
